(19) United States
(12) Patent Application Publication
(10) Pub. No.: US 2016/0230927 A1
(43) Pub. Date: Aug. 11, 2016

(54) HANGING SYSTEMS AND DEVICES THAT ARE ATTACHABLE TO AN UNDERURFACE

(71) Applicant: Casey Hopkins, Portland, OR (US)

(72) Inventor: Casey Hopkins, Portland, OR (US)

(21) Appl. No.: 14/617,493

(22) Filed: Feb. 9, 2015

(51) Int. Cl. F16M 13/02; F16B 45/00; F16B 11/00

(52) U.S. Cl. CPC F16M 13/02; F16B 11/006; F16B 45/00

(57) ABSTRACT

Hanging devices for holding one or more objects that are hung on an underside of a surface are shown and described. The hanging devices include a base attachable to an undersurface via an attachment mechanism, a trunk extended do downwardly from the base, and one or more arms joined to the trunk and extended horizontally from the trunk. The trunk and the one or more arms are comprised of a sturdy and flexible material so that the hanging device is configured to flex upon impact and is further configured to have limited deformation when receiving the one or more objects.

### BACKGROUND

The present disclosure relates generally to hanging devices for supporting, holding, and/or suspending on an underside of a surface. In particular, hanging devices attachable to an undersurface and comprised of a sturdy and flexible material are described.

Headphones are often used with a computing device at a desk for listening to audio from the computing device. Flanging devices can be associated with a desk where the computing device is located for easy access to the headphones. Further, other items can be hung on the hanging device as desired.

Known hanging devices are not entirely satisfactory for the range of applications which they are employed. For example, existing hanging devices are often comprised of metal. When the metal hanging device is attached to an undersurface of a surface, such as a desk, users may accidently their legs or other body parts (e.g., knees) on the hanging devices as they adjust their seats at the desk causing pain and/or injury. In addition, impact with the body of the hanging device is translated as lever force on the base of the device, often prying the device away from its attachment point on the undersurface. In some cases, the device can be completely detached from the undersurface and drop any items that are supported on the hanging device.

Some other conventional hanging devices are attachable to a side of the desk and project outwardly from the side of the desk, thereby reducing the tidy and uncluttered appearance of the desk and the workspace. Again, in these examples there is a risk that a user may impact the hanging device even when it is located at the side of the desk, causing pain and/or injury to the user.

Thus, there exists a need for hanging devices that improve upon and advance the design of known hanging devices. Examples of new and useful hanging devices relevant to the needs existing in the field are discussed below.

Disclosure addressing one or more of the identified existing needs is provided in the detailed description below. Examples of references relevant to hanging devices include U.S. Patent References: U.S. Pat. Nos. 5,458,301, 7,219,868, and 918,066. The complete disclosures of the above patents are herein incorporated by reference for all purposes.

### SUMMARY

The present disclosure is directed to hanging devices for holding one or more objects that are hung on an underside of a surface. The hanging devices include a base attachable to undersurface via an attachment mechanism, a trunk extended downwardly from the base, and one or more arms joined to the trunk and extended horizontally from the trunk. The trunk and the one or more arms are comprised of sturdy and flexible material so that the hanging device is configured to flex upon impact and is further configured to have limited deformation when receiving the one or more objects. In some examples, the one or more arms include upward projections at distal ends of each arm. In some further examples, the base and the upward projections are also comprised of the sturdy and flexible material, and the base, the trunk, the one or more arms, and the upward projections are a co-molded hanging device body.

### BRIEF DESCRIPTION OF THE DRAWINGS

FIG. 1 is a perspective view of a first example of a hanging device.

FIG. 2 is a front elevation view of the first example hanging device shown in FIG. 1 in a substantially non-flexed position.

FIG. 3 is a front elevation view of the first example hanging device shown in FIG. 1 in a flexed position.

FIG. 4 is a top plan view of the first example hanging device shown in FIG. 1 depicting a first example attachment mechanism.

FIG. 5 is a front elevation view of the first example hanging device shown in FIG. 1 depicting the hanging device attached to an underside of a surface.

FIG. 6 is a front elevation view of the first example hanging device shown in FIG. 1 depicting two pairs of headphones hung on opposing arms of the hanging device.

FIG. 7 is a perspective view of the first example hanging device shown in FIG. 1 depicting a bag hung on one of the arms of the hanging device.

### DETAILED DESCRIPTION

The disclosed hanging devices will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various hanging devices are provided. Related features in the examples may be identical, similar, or dissimilar in different examples. For the sake of brevity; related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

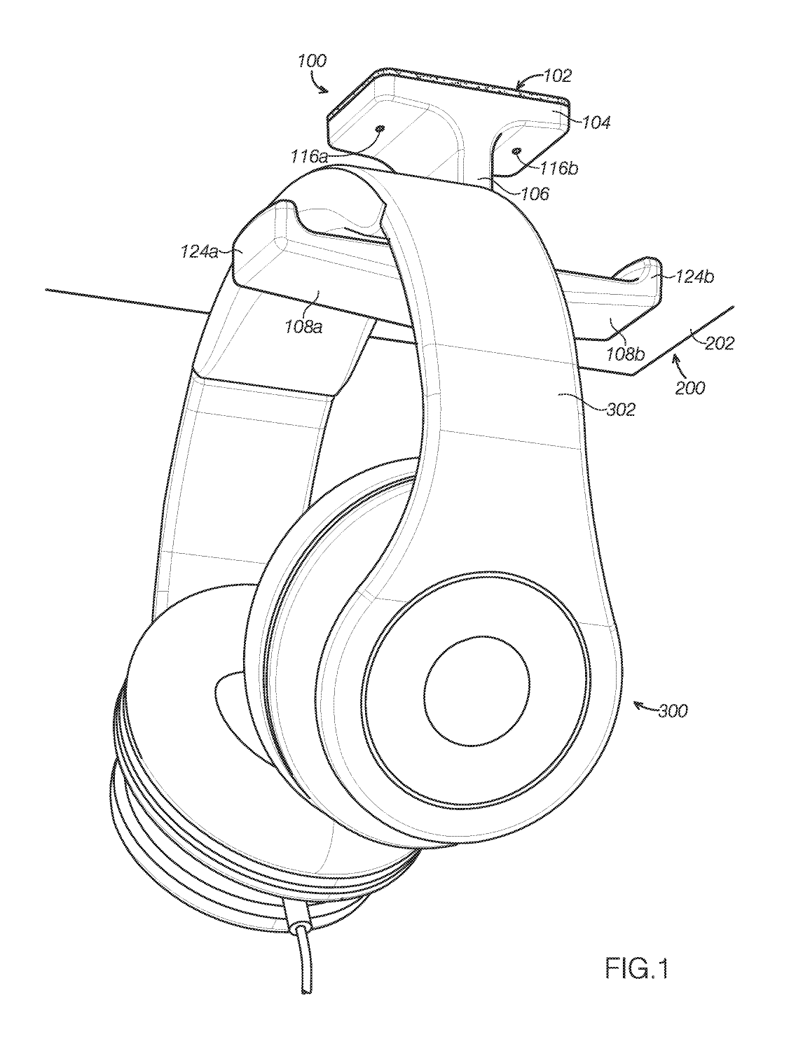

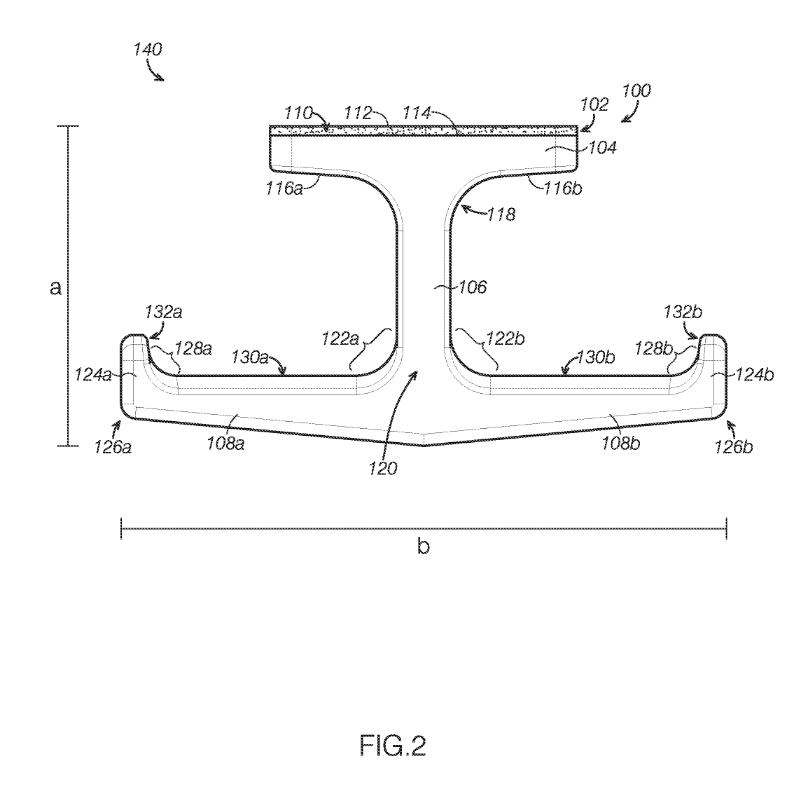

With reference to FIGS. 1-7 a first example of a hanging device for holding, supporting, and/or suspending objects from the underside of a surface, hanging device 100, will now be described. Hanging device 100 functions to attach to an undersurface, such as an underside of a table or a desk, and provide a location for hanging of objects underneath the surface. Additionally, hanging device 100 is configured to remain in a substantially non-flexed position undergo limited movement) when one or more objects are hung on the hanging device, and is further configured to flex (i.e., be moveable into a flexed position) upon impact, such as during impact with a knee of a user. Hanging device 100 is shown in a substantially non flexed position 140 is FIGS. 1, 2, and 4-7, and is shown in a flexed position 142 in FIG. 2.

Hanging device 100 addresses many of the shortcomings existing with conventional surface attachable hanging devices. For example, the presently described hanging device is comprised of a sturdy and flexible material that undergoes limited deformation (i.e., substantially maintains its shape) when the hanging device receives an object, but flexes upon impact or with application of a strong force. In another example, the presently described hanging device is attachable to an undersurface so that a tidy and uncluttered appearance of the desk and workspace is maintained.

As can be seen in FIGS. 1-7, hanging device 100 includes an attachment mechanism 102, a base 104, a trunk 106, and arms 108a and 108b. As depicted in FIGS. 1 and 5-7 hanging device 100 is attachable to a planar surface 200 (e.g., a desk, a table, a bar, etc.) on an underside of the surface, undersurface 202. Hanging device 100 can be attached to undersurface 202 via attachment mechanism 102, which is associated with base 104.

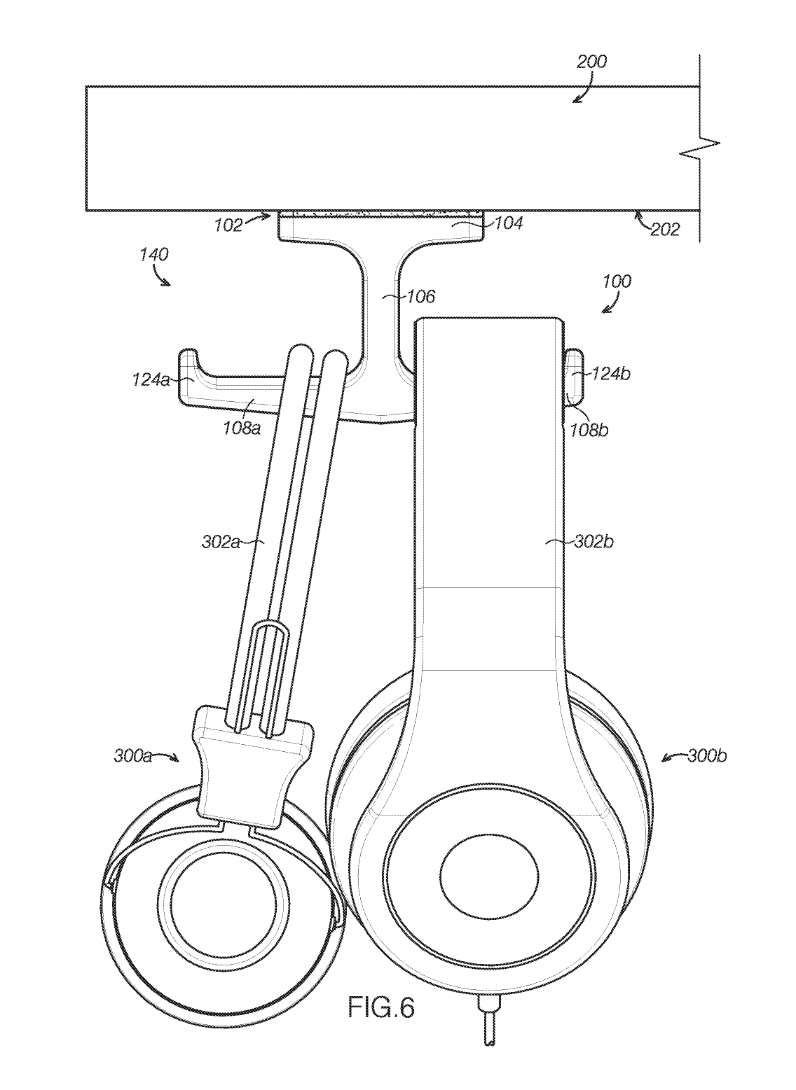

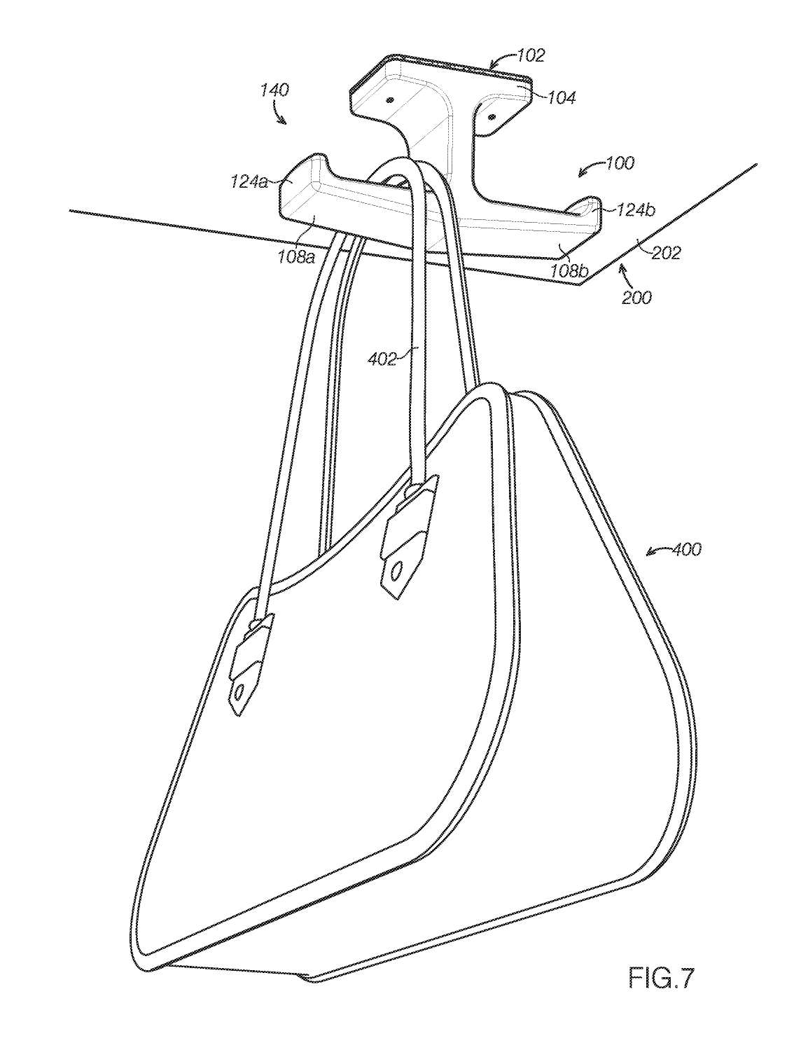

Hanging device 100 can support and/or hold one or more objects that are hung on underneath the surface, such as headphones 300. Specifically, trunk 106 is vertically extended downwardly from base 104 and arms 108a and 1084 are extended in opposing horizontal directions from trunk 106. Each of the arms is configured to receive an object for hanging. In the example shown in FIG. 1, hanging device 100 holds one pair of headphones (i.e., headphones 300), and a headband 302 of headphones 300 is supported and/or held by arm 108a. In the example shown in FIG. 6, hanging device 100 holds two pairs of headphones (i.e., headphones 300a and 300b), and headband 302a is supported and/or held by arm 108a, while headband 3024 is supported and/or held by arm 1084. In the example of FIG. 7, hanging device 100 holds a bag 400, and strap 402 of the bag is supported and/or held by arm 108a.

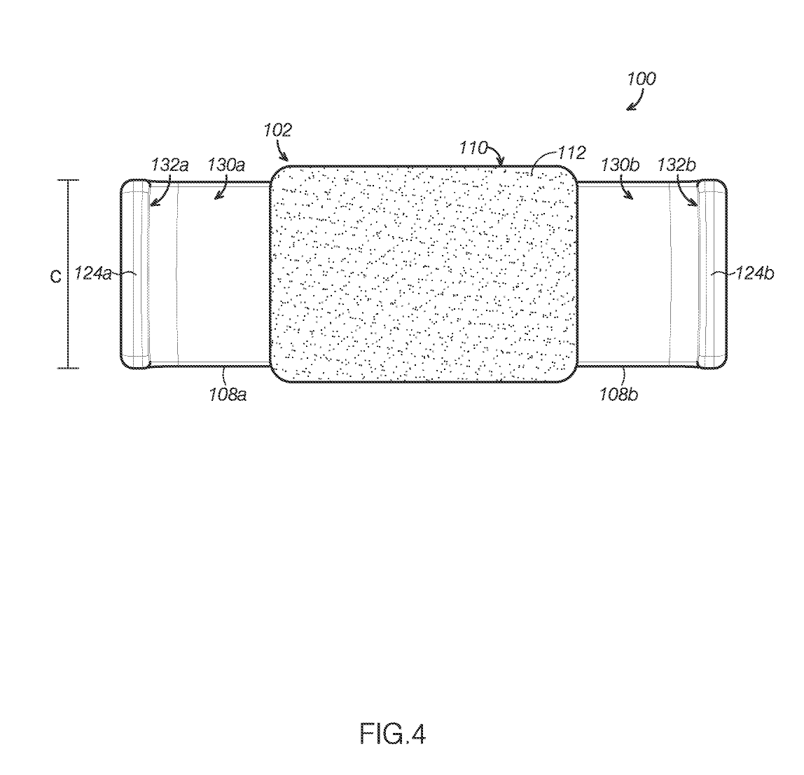

As shown in FIGS. 2 and base 102 is horizontally disposed relative to horizontal surface and includes attachment mechanism 104. In the present example, attachment mechanism 104 includes a pad 110 having a strong adhesive on an outer surface 112 of the pad (also shown in FIG. 4). An opposing inner surface 114 of pad 110 is attached and/or adhered to the base. In one specific example, the pad and adhesive can be an acrylic adhesive on a foam pad, such as 3M™ acrylic adhesive on a urethane foam pad. Further, in the present example, attachment mechanism 104 includes two holes 116a and 116b that are configured for alignment with holes in the undersurface and insertion of fastening members through the aligned holes (not specifically shown). In alternate examples, one of the adhesive pad and the holes can be excluded from the base. In other alternate examples, one or more other attachment features (e.g., clamps, slide fit braces, etc.) can be included in the attachment mechanism.

As described above, trunk 106 is extended downwardly from base 104 and is substantially vertically disposed relative to base 104. Specifically, a first end 118 of trunk 106 is joined (e.g., attached, fused, connected, co-molded, etc.) to base 104. An opposing distal end 120 of trunk 106 is joined to arms 108a and 108b. It will be appreciated that in alternate examples the hanging device can include more or fewer arms joined to the distal end of the trunk. For example, the hanging device can include one arm, three arms, or four arms.

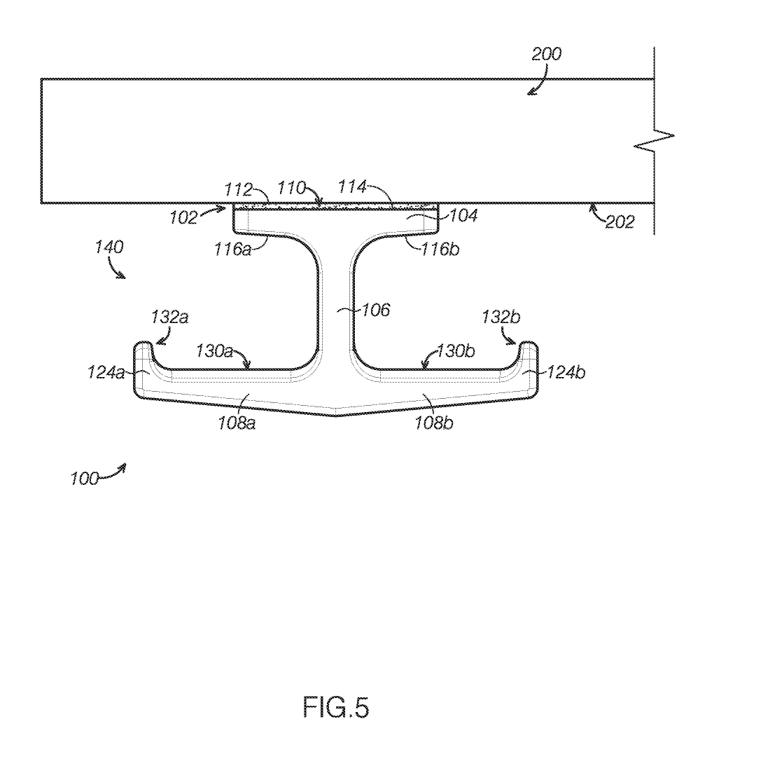

Also shown in FIGS. 2 and 5, first arm 108a is extended outwardly from trunk 106 in a first horizontal direction and second arm 108b is extended outwardly from trunk 106 in a second horizontal direction. In the present example, arms 108a and 108b are substantially horizontally disposed relative to the trunk. Accordingly, angles 122a and 122b between the arms and the trunk are approximately right angles (i.e., approximately 90 degree angles). In alternate examples, the first and the second arm can be disposed upwardly. In these alternate examples, the angles between the trunk and the arms are less than 90 degrees.

Arms 108a and 108b further include upward projections 124a and 124b, respectively. Specifically, upward projection 124a is disposed on a distal end 126a of first arm 108a, while upward projection 124b is disposed on a distal end 126b of second arm 108b. In the present example, the upward projections are vertically disposed (i.e., aligned with the trunk) relative to the arms. Accordingly, in the present example, angles 128a and 128b between the upward projections and the arms are approximately right angles approximately 90 degree angles). In alternate examples, the upward projections can be inwardly or outwardly disposed. In one specific alternate example, the angles between the upward projections and the arms are less than 90 degrees when the projections are inwardly disposed. In another specific alternate example, the angles between the upward projections and the arms are greater than 90 degrees when the projections are outwardly disposed.

Upper surfaces 130a and 130b of arms 108a and 108b, respectively, are configured to receive a portion of an object for holding, supporting, and/or suspending of the object underneath the surface. Inner surfaces 132a and 132b of upward projections 124a and 124b, respectively, are configured to prevent the object from unintentionally slipping off the arms. In other words, an inner surface of each the projection can be abutted to an object hanging on the arm when the object is on or close to the distal end of the arm.

As described above, FIG. 6 shows an example where two pairs of headphones 300a and 300b are held, supported, and/or suspended by hanging device 100. Specifically, headband 302a makes surface-to-surface contact with upper surface 130a. If headband 302a is moved toward distal end 126a, the headband will be abutted to inner surface 132a. Similarly, headband 302b makes surface-to-surface contact with upper surface 130b, but also makes further surface-to-surface to inner surface 132b. In this example, headband 302b is wider than headband 302a and therefore contacts inner surface 132b. It will be appreciated that headphones 300 shown in FIG. 1 and bag 400 shown in FIG. 7 are similarly associated with hanging device 100. It will be further appreciated that the hanging objects are merely example objects and the hanging devices can hold, support, and/or suspend other types of objects cords, wires, jackets, hats, flashlights, etc.) and other combinations of objects (e.g., a pair of headphones on one arm and a bag on the other arm).

Returning to FIGS. 2 and 4, hanging device 100 has an overall height a, an overall length b, and an overall width c. In one specific example, the height a is 2″, the length b is 4″, and the width c is 1.5″. It will be appreciated that the dimensions of hanging device 100 are selected to as to accommodate one or two pairs of headphones. For example, the length is selected so that the arms can each accommodate a head band of a pair of headphones and the width is selected so that the arms have the structural integrity to support the weight of the headphones. It will be appreciated that in alternate examples the hanging device can have different dimensions. In these alternate examples, dimensions can be selected to accommodate and have the structural integrity to support other types of objects (e.g., bags, purses, wires, cords, jackets, hats, flashlights, etc.).

In the present example, the base, the trunk, the arms, and the upward projections are comprised of a sturdy material that is also flexible (i.e., a sturdy and flexible material). Further, in the present example, the base, the trunk, the arms, and the upward projections are co-molded and therefore comprise a co-molded hanging device body. In one example, the sturdy and flexible material is silicone rubber or another thermoplastic elastomer. In one specific example, the silicon rubber is shore A 70 durometer silicone rubber.

It will be appreciated that in other examples the hanging device can be comprised of different material that is sufficiently sturdy to support the weight of an object and sufficiently flexible to flex upon impact, such as other rubber compositions, other silicone composition, and/or any other sturdy and flexible material known or yet to be discovered. It will be further appreciated that one or more components may be comprised of another flexible material or flexible structure. For example, the trunk can be comprised of a semi-rigid spring with silicone arms attached to a bottom end of the string. It will be even further appreciated that in some examples either or both of the arms and the base can be comprised of a harder material, such as ABS plastic, attached to a flexible trunk.

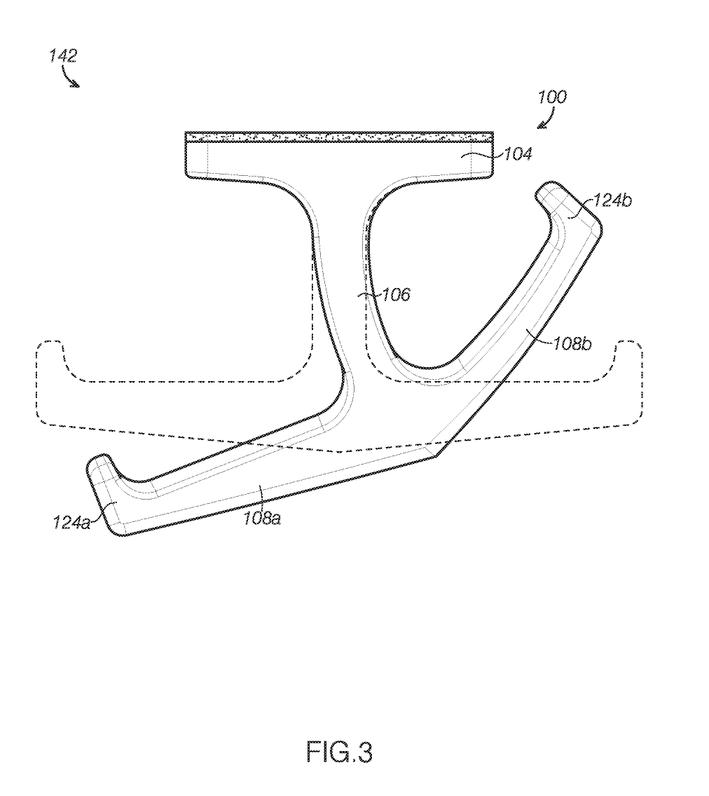

As described above, FIGS. 1, 2, and 5-7 show hanging device 100 in a substantially non-flexed position 140 and FIG. 3 shows hanging device 100 in flexed position 142. Because of the sturdiness of the sturdy and flexible material, the hanging device is sufficiently strong to substantially maintain its shape (i.e., undergo limited deformation) and be in substantially non-flexed position when it receives one or more objects. Further, because of the flexibility of the sturdy and flexible material, the hanging device is sufficiently flexible to flex during impact and/or under application of a strong force.

In the example of FIG. 3, flexed position 142 shows arm 108b upwardly flexed. It will be appreciated that in other examples other portions of the body (e.g., trunk 106, arm 108a, etc.) can be flexed depending upon the location of an impact or a strong force being applied. Accordingly, hanging device 100 has the advantage that if the hanging device is hit by a body part of a user (e.g. the knee of a user) the device flexes and causes no or reduced pain as compared to a hanging device comprised of an inflexible material. Further, hanging device 100 has the additional advantage that it is resistant to be accidently removed (i.e., knocked off) by impact. Namely, as the body flexes proximal to the point of impact, lever forces on the base are reduced as compared to a hanging device comprised of an inflexible material.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in Me art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A hanging device for holding one or more objects that are hung on an underside of a surface, the hanging device comprising:
a base that is attachable to an undersurface of the surface via an attachment mechanism;
a trunk extended downwardly from the base, the trunk having a first end joined to the base and a second end that is distal relative to the base; and
a first arm joined to the second end of the trunk and extended in a first horizontal direction away from the trunk;
a first upward projection on a distal end of the first arm:
a second arm joined to the second end of the trunk and extended in a second horizontal direction opposing the first horizontal direction; and
a second upward projection on a distal end of the second arm
wherein the first arm, second arm, first upward projection and second upward projection together with the trunk comprise a T shape:
wherein the trunk and the first and second arms are comprised of a sturdy and flexible material, and
wherein the hanging device is configured to flex upon impact and is further configured to have limited deformation when receiving the one or more objects.

2-3. (canceled)

4. The hanging device of claim 1, wherein the first upward projection and the second upward projection are comprised of the sturdy material, and
the trunk, the first arm, the second arm, the first upward projection, and the second upward projection comprise a co-molded hanging device body.

5. The hanging device of claim 4, wherein the base is comprised of the sturdy material, and
the base, the trunk, the first arm, the second arm, the first upward projection, and the second upward projection comprise the co-molded hanging device body.

6. The hanging device of claim 1, wherein the first arm and the second arm are horizontally disposed relative to the trunk.

7. The hanging device of claim 6, wherein the first projection is vertically disposed relative to the first arm and the second projection is vertically disposed relative to the second arm.

8. The hanging device of claim 1, wherein the first arm is shaped as to receive a headband of a first pair of headphones and the second arm is shaped as to receive a headband of a second pair of headphones.

9. The hanging device of claim 1, wherein the attachment mechanism comprises a strong adhesive.

10. The hanging device of claim 1, wherein the attachment mechanism comprises one or more holes for insertion of a fastening member through the holes that are aligned with holes in the underside of the surface.

11. The hanging device of claim 1, wherein the at least one arm has an upward projection at a distal end of the at least one arm, the at least one arm being horizontally disposed relative to the base and the upward projection being vertically disposed relative to the at least one arm, and
the at least one arm is shaped as to receive a headband of a pair of headphones.

12. The hanging device of claim 1, wherein the sturdy material is silicone rubber.

13-17. (canceled)

18. The hanging device of claim 1, wherein the first arm is shaped as to receive a headband of a first pair of headphones and the second arm is shaped as to receive a headband of a second pair of headphones.

19-20. (canceled)
